(19) United States
(12) Patent Application Publication
(10) Pub. No.: US 2021/0252769 A1
(43) Pub. Date: Aug. 19, 2021

(54) HEAT-SHRINKABLE ARTICLE

(71) Applicant: SOLVAY SPECIALTY POLYMERS ITALY S.P.A., Bollate (IT)

(72) Inventors: Nicola RANIERI, Monza (IT); Matteo FANTONI, Vanzaghello (IT); Valerio PENNISI, Cesate (IT)

(21) Appl. No.: 17/055,245

(22) PCT Filed: May 16, 2019
(86) PCT No.: PCT/EP2019/062550

§ 371 Date: Nov. 13, 2020

(30) Foreign Application Priority Data
May 17, 2018 (EP) 18172985.6

(51) Int. Cl. B29C 61/02; C08K 5/14; B29C 61/08; C08F 214/22; C08L 53/00

(52) U.S. Cl. CPC B29C 61/025; C08K 5/14; B29K 2021/003; C08F 214/22; C08L 53/00; B29C 61/08

(57) ABSTRACT

The present invention relates to heat-shrinkable articles, including tubes, O-ring, sleeves, sealants possessing outstanding elastomeric properties, ability to elastic deformation beyond 200%, and ability to precisely and completely recover design dimensions, while possessing significantly improved mechanical properties, in particular higher tensile strength; to a method of making the same, and to a method of using the same including reverting to a shrunk state. The heat shrinkable article is made of a composition comprising at least one fluorinated thermoplastic elastomer comprising at least one elastomeric block and one thermoplastic block, iodine and/or bromine cure sites, at least one organic peroxid, and at least one polyunsaturated compound.

### CROSS-REFERENCE TO RELATED APPLICATION

This application claims priority to European Patent Application No. 18172985.6 filed May 17, 2018 the whole content of this application being incorporated herein by reference for all purposes.

### TECHNICAL FIELD

The present invention relates to heat-shrinkable articles, including tubes, O-ring, sleeves, sealants; to a method of making the same, and to a method of using the same including reverting to a shrunk state.

### BACKGROUND ART

Heat-shrinkable or heat-recoverable articles are shaped parts whose dimensional configuration may be made to change when subjected to an appropriate thermal treatment. More specifically, heat-shrinkable articles are shaped parts which have undergone a permanent deformation, but which, on heating, are able to recover their original shrunk state.

Heat shrink tubing was originally developed by Raychem Corporation in the late 1950s, based on the use of radiation chemistry; fluororubbers were among the constituent materials considered for heat shrinkable sleeves intended to deliver heat resistance, oil resistance, and corrosion resistance. While Raychem pioneered heat shrink polymers, fluoroelastomer-based heat shrinkable tubings are today produced by many different manufacturers.

Heat shrink tubings available in the market may be made of a range of cross-linked plastics, including polyolefin, polyvinyl chloride (PVC), Viton® fluororubbers (for high-temp and corrosive environments), Neoprene®, polytetrafluoroethylene (PTFE), fluorinated ethylene propylene (FEP) and Kynar® fluoroplasts.

It is generally understood that cross-linking creates covalent bonds between the polymers' chains, so that crosslinked plastics wouldn't melt or develop a flowing consistency, no matter what temperatures they were exposed to. Said covalent bonds are also believed to provide polymers with plastic memory, which means that once a polymer has been cross-linked and stretched into an expanded shape, and frozen by appropriate means in said expanded form, it will automatically shrink back to its original dimensions when a certain amount of heat is applied.

As said, heat-shrinkable articles, including sleeves and tubings, based on crosslinked fluororubbers are common staple articles of commerce, which are sold in a thermally unstable stretched/deformed state, corresponding to up to 200% deformation. Upon heating in prescribed conditions, plastic recovery reverts back these sleeves and tubings to their heat-stable original shape, with precision and predictability, making hence these materials the solution of choice for certain assembling challenges.

In this area, fluoroelastomer-based heat-shrinkable articles have been provided whereas the fluororubber matrix has been reinforced with a thermoplastic polymer, so as to confer to the resulting shaped part improved tensile strength.

For instance, U.S. Pat. No. 4,489,113 discloses fluorubber-based heat-shrinkable tubes made from compositions comprising fluororubbers as major component, in admixture with a variety of crystalline polymers.

Similarly, U.S. Pat. No. 4,935,467 discloses certain polymer blends which may be used for making heat-recoverable articles. The blends taught in this document include (A) a thermoplastic polymer selected from (i) ethylene and tetrafluoroethylene copolymers and (ii) thermoplastic vinylidene fluoride polymers and (B) a thermoplastic elastomer having an elastomeric segment and a non-elastomeric segment of ethylene and tetrafluoroethylene or of vinylidene fluoride, hexafluoropropylene and tetrafluoroethylene, which are radiation crosslinked to provide shaped parts.

Still, U.S. Pat. No. 5,057,345 discloses blends which may be crosslinked for producing heat-shrinkable articles. The blends thereby disclosed include (A) a fluorinated ethylene-propylene copolymer and (B) a fluoroelastomer, which may be a block copolymeric fluoroelastomer having an elastomeric segment of tetrafluoroethylene, vinylidene fluoride, and hexafluoropropylene, and a non-elastomeric segment of ethylene and tetrafluoroethylene, which are radiation crosslinked to provide shaped parts.

In this field, there remains nevertheless a continuous quest for heat-shrinkable parts possessing improved mechanical properties, in particular higher tensile strength, while maintaining all advantageous features of fluororubbers-based heat-shrinkable articles.

### SUMMARY OF INVENTION

The invention thus pertains to a heat shrinkable article made from a composition [composition (C)] comprising:
at least one fluorinated thermoplastic elastomer [polymer (F-TPE)] comprising:

(i) at least one elastomeric block (A) consisting of a sequence of recurring units, said sequence comprising recurring units derived from at least one fluorinated monomer, said block (A) possessing a glass transition temperature of less than 25° C., as determined according to ASTM D3418,

(ii) at least one thermoplastic block (B) consisting of a sequence of recurring units derived from vinylidene fluoride (VDF) in an amount of more than 80% moles, with respect to the total moles of units of block (B), and optionally from one or more than one additional fluorinated monomer different from VDF,

wherein:
polymer (F-TPE) has a detectable melting point, when determined according to ASTM D3418; and
polymer (F-TPE) possesses heat of fusion of at least 2.5 J/g and of at most 20.0 J/g, when determined according to ASTM D3418; and

(iii) iodine and/or bromine cure sites in an amount such that the overal iodine and/or bromine content of the polymer (F-TPE) is of 0.01 to 10.00% wt, with respect to the total weight of polymer (F-TPE);
at least one organic peroxide [peroxide (O)]; and
at least one polyunsaturated compound [compound (U)].

The invention further pertains to a method of making a heat shrinkable article, said method comprising:

(1) a step of shaping and crosslinking a composition [composition (C)] comprising:
at least one fluorinated thermoplastic elastomer [polymer (F-TPE)] comprising:

(i) at least one elastomeric block (A) consisting of a sequence of recurring units, said sequence comprising recurring units derived from at least one fluorinated monomer, said block (A) possessing a glass transition temperature of less than 25° C., as determined according to ASTM D3418,

(ii) at least one thermoplastic block (B) consisting of a sequence of recurring units derived from vinylidene fluoride (VDF) in an amount of more than 80% moles, with respect to the total moles of units of block (B), and optionally from one or more than one additional fluorinated monomer different from VDF,

wherein:
polymer (F-TPE) has a detectable melting point, when determined according to ASTM D3418; and
polymer (F-TPE) possesses heat of fusion of at least 2.5 J/g and of at most 20.0 J/g, when determined according to ASTM D3418; and

(iii) iodine cure site in an amount such that the iodine content of the polymer (F-TPE) is of 0.01 to 1.00% wt, with respect to the total weight of polymer (F-TPE);
at least one organic peroxide [peroxide (O)]; and
at least one polyunsaturated compound [compound (U)];

so as to obtain a shaped crosslinked article having a heat stable three dimensional shape;

(2) a step of heating the said shaped article at a temperature equal to or exceeding melting point of polymer (F-TPE) while applying a deformation, so as to obtain a stretched shaped article having a heat unstable three dimensional shape which is stretched in at least one dimension with respect to the heat stable three dimensional shape of the shaped crosslinked article; and

(3) a step of cooling said stretched shaped article to a temperature of lower than 50° C. below said melting point of polymer (F-TPE), while continuing applying the said deformation, so as to obtain the heat shrinkable article.

Further, the invention pertains to a method of changing the dimensional shape of the heat shrinkable article as above detailed and/or made by the method as above detailed, said method comprising a step of heating said heat shrinkable article to a temperature equal to or exceeding melting point of polymer (F-TPE), so as to cause the said heat shrinkable article to shrink to a heat stable three dimensional shape.

The Applicant has found that the careful selection of the combination of the polymer (F-TPE), possessing VDF-based thermoplastic phase, well-defined mentioned crystallinity (as expressed through its heat of fusion requirements) and iodine cure-sites, and of an organic peroxide, activating those iodine and/or bromine cure sites, is such to provide for heat-shrinkable articles which possess outstanding elastomeric properties, ability to elastic deformation beyond 200%, and ability to precisely and completely recover design dimensions, while possessing significantly improved mechanical properties, in particular higher tensile strength.

### DESCRIPTION OF EMBODIMENTS

The fluorinated thermoplastic elastomer [polymer (F-TPE)]

For the purpose of the present invention, the term “elastomeric”, when used in connection with the “block (A)” is hereby intended to denote a polymer chain segment which, when taken alone, is substantially amorphous, that is to say, has a heat of fusion of less than 2.0 J/g, preferably of less than 1.5 J/g, more preferably of less than 1.0 J/g, as measured according to ASTM D3418.

For the purpose of the present invention, the term “thermoplastic”, when used in connection with the “block (B)”, is hereby intended to denote a polymer chain segment which, when taken alone, is semi-crystalline, and possesses a detectable melting point, with an associated heat of fusion of exceeding 10.0 J/g, as measured according to ASTM D3418.

The fluorinated thermoplastic elastomer of the composition (C) of the invention is advantageously a block copolymer, said block copolymer typically having a structure comprising at least one block (A) alternated to at least one block (B), that is to say that said fluorinated thermoplastic elastomer typically comprises, preferably consists of, one or more repeating structures of type (B)-(A)-(B). Generally, the polymer (F-TPE) has a structure of type (B)-(A)-(B), i.e. comprising a central block (A) having two ends, connected at both ends to a side block (B).

The block (A) is often alternatively referred to as soft block (A); the block (B) is often alternatively referred to as hard block (B).

The term “fluorinated monomer” is hereby intended to denote an ethylenically unsaturated monomer comprising at least one fluorine atom.

The fluorinated monomer may further comprise one or more other halogen atoms (Cl, Br, I).

Any of block(s) (A) and (B) may further comprise recurring units derived from at least one hydrogenated monomer, wherein the term “hydrogenated monomer” is intended to denote an ethylenically unsaturated monomer comprising at least one hydrogen atom and free from fluorine atoms.

The elastomeric block (A) may further comprise recurring units derived from at least one bis-olefin [bis-olefin (OF)] of formula:

R_{A}R_{B}═CR_{C}-T-CR_{D}═R_{E}R_{F}

wherein R_{A}, R_{B}, R_{C}, R_{D}, R_{E} and R_{F}, equal to or different from each other, are selected from the group consisting of H, F, Cl, C₁-C₅ alkyl groups and C₁-C₅ (per)fluoroalkyl groups, and T is a linear or branched C₁-C₁₈ alkylene or cycloalkylene group, optionally comprising one or more than one ethereal oxygen atom, preferably at least partially fluorinated, or a (per)fluoropolyoxyalkylene group.

The bis-olefin (OF) is preferably selected from the group consisting of those of any of formulae (OF-1), (OF-2) and (OF-3):

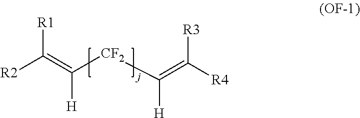

wherein j is an integer comprised between 2 and 10, preferably between 4 and 8, and R1, R2, R3 and R4, equal to or different from each other, are selected from the group consisting of H, F, C₁-C₅ alkyl groups and C₁-C₅ (per)fluoroalkyl groups;

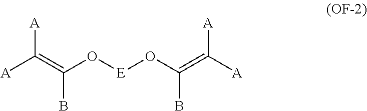

wherein each of A, equal to or different from each other and at each occurrence, is independently selected from the group consisting of H, F and Cl; each of B, equal to or different from each other and at each occurrence, is independently selected from the group consisting of H, F, Cl and OR_{B}, wherein R_{B} is a branched or straight chain alkyl group which may be partially, substantially or completely fluorinated or chlorinated, E is a divalent group having 2 to 10 carbon atoms, optionally fluorinated, which may be inserted with ether linkages; preferably E is a —(CF₂)ₘ— group, wherein m is an integer comprised between 3 and 5; a preferred bis-olefin of (OF-2) type is F₂C═CF—O—(CF₂)₅—O—CF═CF₂;

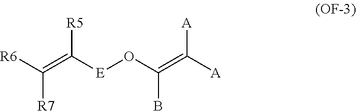

wherein E, A and B have the same meaning as defined above, R5, R6 and R7, equal to or different from each other, are selected from the group consisting of H, F, C₁-C₅ alkyl groups and C₁-C₅ (per)fluoroalkyl groups.

Should the block (A) consist of a recurring units sequence further comprising recurring units derived from at least one bis-olefin (OF), said sequence typically comprises recurring units derived from the said at least one bis-olefin (OF) in an amount comprised between 0.01% and 1.0% by moles, preferably between 0.03% and 0.5% by moles, more preferably between 0.05% and 0.2% by moles, based on the total moles of recurring units of block (A).

The polymer (F-TPE) typically comprises, preferably consists of:
at least one elastomeric block (A) selected from the group consisting of:

(1) vinylidene fluoride (VDF)-based elastomeric blocks (A_{VDF}) consisting of a sequence of recurring units, said sequence comprising recurring units derived from VDF and recurring units derived from at least one fluorinated monomer different from VDF, said fluorinated monomer different from VDF being typically selected from the group consisting of:

(a) C₂-C₈ perfluoroolefins such as tetrafluoroethylene (TFE), hexafluoropropylene (HFP);

(b) hydrogen-containing C₂-C₈ fluoroolefins different from VDF, such as vinyl fluoride, trifluoroethylene (TrFE), hexafluoroisobutylene (HFIB), perfluoroalkyl ethylenes of formula CH₂═CH—R_{f1}, wherein R_{f1} is a C₁-C₆ perfluoroalkyl group;

(c) C₂-C₈ chloro-containing fluoroolefins such as chlorotrifluoroethylene (CTFE);

(d) perfluoroalkylvinylethers (PAVE) of formula CF₂═CFOR_{f1}, wherein R_{f1} is a C₁-C₆ perfluoroalkyl group, such as CF₃ (PMVE), C₂F₅ or C₃F₇;

(e) perfluorooxyalkylvinylethers of formula CF₂═CFOX₀, wherein Xo is a a C₁-C₁₂ perfluorooxyalkyl group comprising one or more than one ethereal oxygen atom, including notably perfluoromethoxyalkylvinylethers of formula CF₂═CFOCF₂OR_{f2}, with R_{f2} being a C₁-C₃ perfluoro(oxy)alkyl group, such as —CF₂CF₃, —CF₂CF₂—O—CF₃ and —CF₃; and

(f) (per)fluorodioxoles of formula:

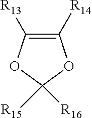

wherein each of R_{f5}, R_{f4}, R_{f5} and R_{f6}, equal to or different from each other, is independently a fluorine atom, a C₁-C₆ perfluoro(oxy)alkyl group, optionally comprising one or more oxygen atoms, such as —CF₃, —C₂F₅,—C₃F, —OCF₃ or —OCF₂CF₂OCF₃;

(g) bromo and/or iodo alpha-olefins containing from 2 to 10 carbon atoms such as bromotrifluoroethylene or bromotetrafluorobutene, such as those described, for example, in U.S. Pat. No. 4,035,565 (DU PONT) 12.07.1977 or other compounds bromo and/or iodo alpha-olefins disclosed in U.S. Pat. No. 4,694,045 (DU PONT) 15.09.1987; and

(h) iodo and/or bromo fluoroalkyl vinyl ethers (as notably described in patents U.S. Pat. Nos. 454,662, 4,564,662 (MINNESOTA MINING) 14.01.1986 and EP 199138 A (DAIKIN IND LTD) 29.10.1986); and

(2) tetrafluoroethylene (TFE)-based elastomeric blocks (A_{TFE}) consisting of a sequence of recurring units, said sequence comprising recurring units derived from TFE and recurring units derived from at least one fluorinated monomer different from TFE, said fluorinated monomer being typically selected from the group consisting of those of classes (a), (b), (c), (d), (e), (f), (g), (h), as defined above;
at least one thermoplastic block (B) consisting of a sequence of recurring units derived from vinylidene fluoride (VDF) in an amount of more than 80% moles, with respect to the total moles of units of block (B), and optionally from one or more than one additional fluorinated monomer different from VDF.

Any of block(s) (A_{VDF}) and (ATFE) may further comprise recurring units derived from at least one hydrogenated monomer, which may be selected from the group consisting of C₂-C₈ non-fluorinated olefins such as ethylene, propylene or isobutylene, and may further comprise recurring units derived from at least one bis-olefin (OF), as above detailed.

The elastomeric block (A) is preferably a block (A_{VDF}), as above detailed, said block (A_{VDF}) typically consisting of a sequence of recurring units comprising, preferably consisting of:
from 45% to 80% by moles of recurring units derived from vinylidene fluoride (VDF),
from 5% to 50% by moles of recurring units derived from at least one fluorinated monomer different from VDF,
optionally, up to 1.0% by moles of recurring units derived from at least one bis-olefin (OF), as above detailed; and
optionally, up to 30% by moles of recurring units derived from at least one hydrogenated monomer,

with respect to the total moles of recurring units of the sequence of block (A_{VDF}).

More specifically, block (B) may be selected from the group consisting of blocks (B_{VDF}) consisting of a sequence of recurring units derived from vinylidene fluoride and optionally from one or more than one additional fluorinated monomer different from VDF, said fluorinated monomer being preferably selected in the group consisting of vinylfluoride (VF1), chlorotrifluoroethylene (CTFE), hexafluoropropene (HFP), tetrafluoroethylene (TFE), perfluoromethylvinylether (MVE), trifluoroethylene (TrFE) and mixtures therefrom, even more preferably being selected from HFP, CTFE, and MVE; and optionally from a hydrogenated monomer, as above detailed, e.g. a (meth)acrylic monomer, whereas the amount of recurring units derived from VDF is of 85 to 100% moles, based on the total moles of recurring units of block (B_{VDF}).

Embodiments whereas block (B_{VDF}) consists of a sequence of recurring units, substantially all of those units being derived from vinylidene fluoride are preferred. Impurities, chains inversions or branchings and the like may be additionally present in the block (B_{VDF}) in addition to the said recurring units derived from VDF, without these components substantially modifying the behaviour and properties of block (B_{VDF}).

The weight ratio between blocks (A) and blocks (B) in the fluorinated thermoplastic elastomer is typically comprised between 95:5 and 70:30, preferably 90:10 to 75:25.

The crystallinity of block (B) and its weight fraction in the polymer (F-TPE) are such to provide for a heat of fusion (ΔH_{f}) of the polymer (F-TPE) of at most 20 J/g, preferably at most 18 J/g, more preferably at most 15 J/g, when determined according to ASTM D3418; on the other side, polymer (F-TPE) combines thermoplastic and elastomeric character, so as to possess a certain crystallinity, delivering a heat of fusion of at least 2.5 J/g, preferably at least 3.0 J/g.

Preferred polymers (F-TPE) are those comprising:
at least one elastomeric block (A_{VDF}), as above detailed, and
at least one thermoplastic block (B_{VDF}), as above detailed, and wherein the crystallinity of said block (B) and its weight fraction in the polymer (F-TPE) are such to provide for a heat of fusion of the polymer (F-TPE) of at least 5 J/g and at most 15 J/g, when determined according to ASTM D3418.

As said, polymer (F-TPE) comprises iodine and/or bromine cure sites.

As said, the amount of iodine and/or bromine cure sites is such that the iodine and/or bromine content is of from 0.01 to 10.00% wt, with respect to the total weight of polymer (F-TPE).

These iodine and/or bromine cure sites might be comprised as pending groups bound to the backbone of the polymer (F-TPE) polymer chain or might be comprised as terminal groups of said polymer chain.

According to a first embodiment, the iodine and/or bromine cure sites are comprised as pending groups bound to the backbone of the polymer (F-TPE) polymer chain; the polymer (F-TPE) according to this embodiment typically comprises recurring units derived from brominated and/or iodinated cure-site comonomers selected from bromo and/or iodo alpha-olefins (g) as described above, and iodo and/or bromo fluoroalkyl vinyl ethers (h) as described above in at least one of its elastomeric block(s) (A).

According to a second preferred embodiment, the iodine and/or bromine cure sites (preferably iodine cure sites) are comprised as terminal groups of the polymer (F-TPE) polymer chain; the polymer (F-TPE) according to this embodiment is generally obtained by addition to the polymerization medium during polymer (F-TPE) manufacture of at least one of:
iodinated and/or brominated chain-transfer agent(s); suitable chain-transfer agents are typically those of formula R_{f}(I)ₓ(Br)_{y}, in which R_{f} is a (per)fluoroalkyl or a (per)fluorochloroalkyl containing from 1 to 8 carbon atoms, while x and y are integers between 0 and 2, with 1≤x+y≤2 (see, for example, U.S. Pat. No. 4,243,770 (DAIKIN IND LTD) 06.01.1981 and U.S. Pat. No. 4,943,622 (NIPPON MEKTRON KK) 24.07.1990); and
alkali metal or alkaline-earth metal iodides and/or bromides, such as described notably in U.S. Pat. No. 5,173,553 (AUSIMONT SRL) 22.12.1992.

Advantageously, for ensuring acceptable reactivity it is generally understood that the content of iodine and/or bromine in the polymer (F-TPE) should be of at least 0.05% wt, preferably of at least 0.06% weight, with respect to the total weight of polymer (F-TPE).

On the other side, amounts of iodine and/or bromine not exceeding preferably 7.00% wt, more specifically not exceeding 5.00% wt, or even not exceeding 4.00% wt, with respect to the total weight of polymer (F-TPE), are those generally selected for avoiding side reactions and/or detrimental effects on thermal stability.

Most preferred polymer (F-TPE) is selected among those comprising iodine cure sites, which are preferably comprised as terminal groups of the polymer (F-TPE) polymer chain, in an amount such that the iodine content is of at least 0.10% wt and of at most 2.00% wt, based on the total weight of polymer (F-TPE).

The composition (C) further comprises at least one organic peroxide [peroxide (O)]; the choice of the said peroxide (O) is not particularly critical provided that the same is capable of generating radicals which activate/are reactive towards the iodine atoms present in polymer (F-TPE). Among most commonly used peroxides, mention can be made of:
di(alkyl/alryl) peroxides, including for instance di-tert-butyl peroxide, 2,5-dimethyl-2,5-bis(tert-butylperoxy)hexane, di(t-butylperoxyisopropyl)benzene, dicumyl peroxide;
diacyl peroxides, including dibenzoyl peroxide, disuccinic acid peroxide, di(4-methylbenzoyl)peroxide, di(2,4-dichlorobenzoyl)peroxide, dilauroyl peroxide, decanoyl peroxide;
percarboxylic acids and esters, including di-tert-butyl perbenzoate, t-butylperoxy-2-ethylhexanoate, 1,1,3,3-tetramethylethylbutyl peroxy-2-ethylhexanoate, 2,5-dimethyl-2,5-di(2-ethylhexanoylperoxy)hexane;
peroxycarbonates including notably di(4-t-butylcyclohexyl)peroxydicarbonate, di(2-phenoxyethyl)peroxydicarbonate, bis[1,3-dimethyl-3-(tert-butylperoxy)butyl] carbonate, t-hexylperoxyisoproprylcarbonate, t-butylperoxyisopropylcarbonate,
perketals such as 1, 1-bis(tert-butylperoxy)cyclohexane and 2, 2-bis(tertbutylperoxy)butane;
ketone peroxides such as cyclohexanone peroxide and acetyl acetone peroxide;
organic hydroperoxides such as cumene hydroperoxide, tert-butyl hydroperoxide, methylethylketone peroxide (otherwise referred to as 2-[(2-hydroperoxybutan-2-yl)peroxy]butane-2-peroxol) and pinane hydroperoxide;
oil-soluble azo initiators such as 2, 2′-azobis (4-methoxy-2. 4-dimethyl valeronitrile), 2, 2′-azobis (2.4-dimethyl valeronitrile), 2,2′-azobis(isobutyronitrile), 2, 2′-azobis(2-cyano-2-butane), dimethyl-2, 2′-azobisdimethyli sobutyrate, dimethyl-2,2′-azobis(2-methylpropionate), 2,2′-azobis(2-methylbutyronitrile), 1,1′-azobis(cyclohexane-I-carbonitrile), 2, 2′-azobis[N-(2-propenyl)-2-methylpropionamide], 1-[(1-cyano-1-methyl ethyl)azo]formamide, 2, 2′-azobis(N-cyclohexyl-2-methylpropionamide), 2,2′-azobis(i sobutyronitrile), 2,2′-azobis(2-cyano-2-butane), dimethyl-2,2′-azobisdimethylisobutyrate, 1,1′-azobis(cyclohexanecarbonitrile), 2-(t-butylazo)-2-cyanopropane, 2,2′-azobis[2-methyl-N-(1, 1)-bis(hydroxymethyl)-2-hydroxyethyl]propionamide, 2, 2′-azobis[2-methyl-N-hydroxyethyl]-proprionamide, 2, 2′-azobis(N, N′-dimethyleneisobutyramine), 2, 2′-azobis(2-methyl-N-[1,1-bis(hydroxymethyl)-2-hydroxyethyl] propionamide), 2,2′-azobis(2-methyl-N-[1,1-bis(hydroxymethyl) ethyl] proprionamide), 2, 2′-azobis[2-5 methyl-N-(2-hydroxyethyl) propionamide], 2,2′-azobis(isobutyramide) dihydrate, 2,2′-azobis(2, 2, 4-trimethylpentane), 2, 2′-azobis(2-methylpropane).

Other suitable peroxide systems are those described, notably, in patent applications EP 136596 A (MONTEDISON SPA) 10/04/1985 and EP 410351 A (AUSIMONT SRL) 30/01/1991, whose content is hereby incorporated by reference.

Choice of the most appropriate peroxide depending upon curing conditions (time, temperature) will be done by one of ordinary skills in the art considering notably ten-hours half time temperature of the peroxide (O).

The amount of peroxide (O) in the composition (C) is generally of 0.1 to 15 phr, preferably of 0.2 to 12 phr, more preferably of 1.0 to 7.0 phr, relative to 100 weight parts of polymer (F-TPE).

As said, the composition (C) comprises at least one polyunsaturated compound or compound (U). The expression “polyunsaturated compound” is hereby intended to designate a compound comprising more than one carbon-carbon unsaturation.

The composition (C) may comprise one or more than one compound (U), as above detailed.

Compounds (U) may be selected from compounds comprising two carbon-carbon unsaturations, compounds comprising three carbon-carbon unsaturations and compounds comprising four or more than four carbon-carbon unsaturations.

Among compounds (U) comprising two carbon-carbon unsaturations, mention can be made of bis-olefins [bis-olefin (OF)], as above detailed, preferably selected from those complying with any of formulae (OF-1), (OF-2) and (OF-3), as above detailed.

Among compounds (U) comprising three carbon-carbon unsaturations, mention can be made of:
tri-substituted cyanurate compounds of general formula:

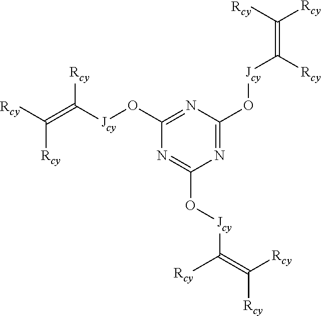

wherein each of R_{cy}, equal to or different from each other and at each occurrence, is independently selected from H or a group —R_{rcy} or —OR_{rcy}, with R_{rcy} being C₁-C₅ alkyl, possibly comprising halogen(s), and each of J_{cy}, equal to or different from each other and at each occurrence, is independently selected from a bond or a divalent hydrocarbon group, optionally comprising heteroatoms; tri-substituted cyanurate compounds include notably preferred triallyl cyanurate, trivinyl cyanurate;
tri-substituted isocyanurate compounds of general formula:

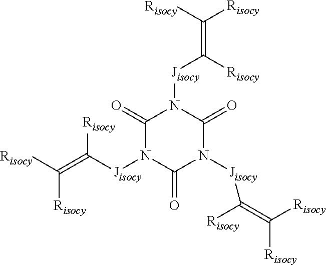

wherein each of R_{isocy}, equal to or different from each other and at each occurrence, is independently selected from H or a group —R_{risocy} or —OR_{risocy}, with R_{risocy} being C₁-C₅ alkyl, possibly comprising halogen(s), and each of J_{isocy}, equal to or different from each other and at each occurrence, is independently selected from a bond or a divalent hydrocarbon group, optionally comprising heteroatoms;

tri-substituted isocyanurate compounds include notably preferred triallyl isocyanurate (otherwise referred to as “TAIC”), trivinyl isocyanurate, with TAIC being the most preferred;
tri-substituted triazine compounds of general formula:

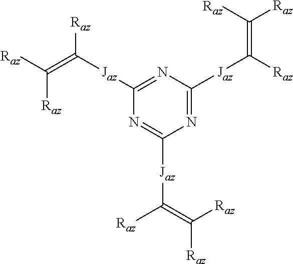

wherein each of R_{az}, equal to or different from each other and at each occurrence, is independently selected from H or a group —R_{raz} or —OR_{raz}, with R_{raz} being C₁-C₅ alkyl, possibly comprising halogen(s), and each of Jaz, equal to or different from each other and at each occurrence, is independently selected from a bond or a divalent hydrocarbon group, optionally comprising heteroatoms; tri-substituted triazine compounds include notably compounds disclosed in EP 0860436 A (AUSIMONT SPA) 26/08/1998 and in WO 97/05122 (DU PONT) 13/02/1997;
tri-substituted phosphite compounds of general formula:

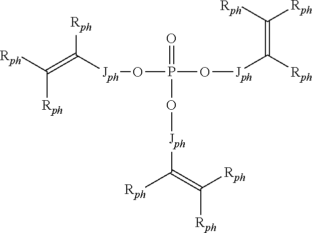

Wherein each of Rₚₕ, equal to or different from each other and at each occurrence, is independently selected from H or a group —Rᵣₚₕ or —ORᵣₚₕ, with Rᵣₚₕ being C₁-C₅ alkyl, possibly comprising halogen(s), and each of Jₚₕ, equal to or different from each other and at each occurrence, is independently selected from a bond or a divalent hydrocarbon group, optionally comprising heteroatoms; tri-substituted phosphite compounds include notably preferred tri-allyl phosphite;
tri-substituted alkyltrisiloxanes of general formula:

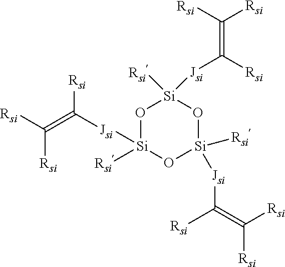

wherein each of Rₛᵢ, equal to or different from each other and at each occurrence, is independently selected from H or a group —Rᵣₛᵢ or —ORᵣₛᵢ, with Rᵣₛᵢ being C₁-C₅ alkyl, possibly comprising halogen(s), each of R′ₛᵢ, equal to or different from each other and at each occurrence, is independently selected from C₁-C₅ alkyl groups, possibly comprising halogen(s), and each of Jₛᵢ, equal to or different from each other and at each occurrence, is independently selected from a bond or a divalent hydrocarbon group, optionally comprising heteroatoms; tri-substituted alkyltrisiloxanes compounds include notably preferred 2,4,6-trivinyl methyltrisiloxane and 2,4,6-trivinyl ethyltrisiloxane; —N,N-disubstituted acrylamide compounds of general formula:

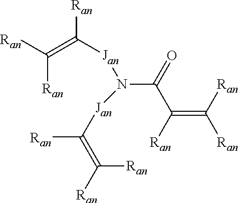

wherein each of Rₐₙ, equal to or different from each other and at each occurrence, is independently selected from H or a group —Rᵣₐₙ or —ORᵣₐₙ, with Rᵣₐₙ being C₁-C₅ alkyl, possibly comprising halogen(s), and each of Jₐₙ, equal to or different from each other and at each occurrence, is independently selected from a bond or a divalent hydrocarbon group, optionally comprising heteroatoms; N,N-disubstituted acrylamide compounds include notably preferred N,N-diallylacrylamide.

Among compounds (U) comprising four or more carbon-carbon unsaturations, mention can be made of tris(diallylamine)-s-triazine of formula

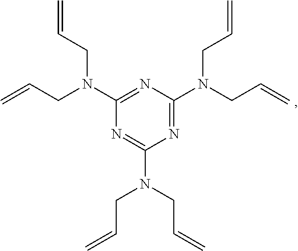 [SMILES: C=CCN(CC=C)c1nc(N(CC=C)CC=C)nc(N(CC=C)CC=C)n1]

hexa-allylphosphoramide, N,N,N′,N′-tetra-allyl terephthalamide, N,N,N′,N′-tetra-allyl malonamide.

It is generally preferred for the compound (U) to be selected from the group consisting of (i) olefins (OF), as above detailed, in particular olefins of (OF-1) type; and (ii) tri-substituted isocyanurate compounds, as above detailed, in particular TAIC. The most preferred compound (U) remains TAIC, which has been found to provide particularly satisfactory results.

The amount of the compound (U) ranges normally from 0.1 to 20 weight parts per 100 parts by weight (phr) of polymer (F-TPE), preferably from 1 to 15 weight parts per 100 parts by weight of polymer (F-TPE), more preferably from 1 to 10 weight parts per 100 parts by weight of polymer (F-TPE).

The composition (C) may further additionally comprise ingredients which maybe commonly used for the peroxide curing of fluororubbers; more specifically, composition (C) may generally further comprise

(a) one or more than one metallic basic compound, in amounts generally of from 0.5 to 15.0 phr, and preferably of from 1 to 10 phr, more preferably 1 to 5 phr, relative to 100 weight parts of polymer (F-TPE); metallic basic compounds are generally selected from the group consisting of (j) oxides or hydroxides of divalent metals, for instance oxides or hydroxides of Mg, Zn, Ca or Pb, and (jj) metal salts of a weak acid, for instance Ba, Na, K, Pb, Ca stearates, benzoates, carbonates, oxalates or phosphites;

(b) one or more than one acid acceptor which is not a metallic basic compound, in amounts generally of from 0.5 to 15.0 phr, and preferably of from 1 to 10.0 phr, more preferably 1 to 5 phr, relative to 100 weight parts of polymer (F-TPE); these acid acceptors are generally selected from nitrogen-containing organic compounds, such as 1,8-bis(dimethylamino)naphthalene, octadecylamine, etc., as notably described in EP 708797 A (DU PONT) 1/05/1996;

(c) other conventional additives, such as fillers, thickeners, pigments, antioxidants, stabilizers, processing aids/plasticizers, and the like.

Nevertheless, it is generally understood that composition (C) will comprise polymer (F-TPE) in an amount of at least 75% wt, preferably at least 80% wt, more preferably at least 85% wt, even more preferably at least 90% wt, with respect to the total weight of the composition (C). Upper boundaries for the amount of polymer (F-TPE) are not particularly limited, being understood that composition (C) shall necessarily comprise effective amounts of peroxide (O) and compound (U), as mentioned above, so that amount of polymer (F-TPE) will generally not exceed 99% wt, preferably not 98% wt, with respect to the total weight of the composition (C).

Compositions (C) essentially consisting of polymer (F-TPE), peroxide (O) and compound (U) are particularly preferred, being understood that minor amounts of impurities, additives such as stabilizers, adjuvants may be present, for instance in an amount of less than 1% wt, with respect to the total weight of the composition (C), without their presence substantially affecting the performances of the composition (C) of the heat-shrinkable article of the invention.

As already explained, the expression “heat shrinkable article” is used hereunder according to its usual meaning, i.e. to designate an article whose dimensional configuration may be made to shrink when subjected to an appropriate thermal treatment.

It is generally understood that a heat shrinkable article may be said to exist in different primary dimensional states which will be herein referred to as heat stable and heat unstable. The expression heat stable is generally used to describe that condition of the article in which all of its internal elastic forces are released and are in equilibrium. In this condition the article will not alter its physical form upon the application of heat. Opposed to this condition is that condition which is termed heat unstable and which expresses the condition of the article in which the elastic forces are not all released and are merely held in the article because of its rigidity at temperatures below melting point of its thermoplastic fraction. From this heat unstable condition the article will, upon the application of heat above said temperature, tend to change irreversibly and automatically into that form or shape in which it last existed in a heat stable condition. In this connection heat stable and unstable have no reference to the chemical stability of the article, but express the state of purely physical forces within the shaped article.

Hence, a heat shrinkable article generally recovers, on heating, towards an original shape from which it has been previously stretched/deformed, said original shape being understood to be advantageously qualified as its heat stable shape.

The actual shape of the heat shrinkable article is not particularly limited. Heat shrinkable articles of the invention may be sleeves, tubes and tubings, O-rings, seals, gaskets and the like, which may found utility in a variety of industries; for instance sleeves may be useful for being installed around pipes, e.g. steel pipes, to the sake of corrosion prevention; tubings may be useful for shielding cables (communication, electrical, optical . . . ) including for shielding connectors between cables; sleeves may be used e.g. as handle grips for a variety of tools, machineries and devices; O-rings and seals may be used as hydraulic seals, piston seals, shaft seals, door sleeves, and the like. In almost all these circumstances, the heat-shrinkable character of the articles of the invention is particularly beneficial for placing the said articles in place for long-term use and operations. For instance, a heat shrinkable article under the form of a sleeve of given heat unstable internal diameter may be easily slide around the outer surface of a pipe to be protected, whose outside diameter is smaller than the said heat unstable internal diameter; upon heating, the sleeve can be made to shrink to a reduced internal diameter so as to firmly adhere to the said surface of the said pipe.

As said, the invention further pertains to a method of making a heat shrinkable article, said method comprising:

(1) a step of shaping and crosslinking a composition [composition (C)], as described above, so as to obtain a shaped crosslinked article having a heat stable three dimensional shape;

(2) a step of heating the said shaped article at a temperature equal to or exceeding melting point of polymer (F-TPE) while applying a deformation, so as to obtain a stretched shaped article having a heat unstable three dimensional shape which is stretched in at least one dimension with respect to the heat stable three dimensional shape of the shaped crosslinked article; and

(3) a step of cooling said stretched shaped article to a temperature of lower than 50° C. below said melting point of polymer (F-TPE), while continuing applying the said deformation, so as to obtain the heat shrinkable article.

Techniques of shaping and crosslinking composition (C) (possessing all the features and preferred characteristics, as detailed above) are not particularly limited. The composition (C), as above detailed, may be shaped and crosslinked according any of injection moulding, compression moulding, extrusion moulding, coating, screen printing technique, form-in-place techniques. In all those techniques, composition (C) will be heated at a temperature advantageously activating reactivity of the peroxide (O) towards compound (U) and cure sites of polymer (F-TPE), so as to simultaneously creating a well-defined shape and curing/creating a crosslinked polymer structure. This step may include an additional heat treatment, generally referred to as “post-cure”, whereas parts are heated e.g. in a static oven, in conditions advantageously enabling crosslinking radical reactions to come to completeness.

The result of this step is a shaped crosslinked article having a heat stable three dimensional shape.

The method further include a step (2) of heating the shaped article obtained from step (1) at a temperature equal to or exceeding melting point of polymer (F-TPE) while applying a deformation.

Means for applying such deformation are not particularly limited. Deformation may be applied in one or more dimensions, although it is generally understood that applied stress may be unidimensional, while the deformation induced may impact all the characterizing dimensions of the shaped article.

Generally, deformation will cause at least one dimension of the shaped article to be increased by at least 30%, preferably at least 50% more preferably at least 100%, and even up to 200% or more, with respect to the original corresponding heat stable dimension.

For instance, applying an elongation stress to a shaped article obtained from step (1) may lead to increasing significantly one characteristic dimension, which we'll refer to as length, while the other dimensions (which we may refer as thickness and width) may be equally affected, e.g. reduced.

When the shaped article obtained from step (1) has a hollow cylindrical elongated shape having heat stable internal and external diameter, thickness and length (e.g. it is a pipe, a tubing, a sleeve, a hand grip, and the like), a circumferential stress may be applied in the radial direction, so as to increase internal and external diameter of the said hollow cylindrical elongated shape, while possibly reducing its thickness and/or affecting its length, so as to generate a stretched shaped article having heat unstable internal and external diameter, thickness and length, where the said internal and external diameters are, respectively, increased versus said heat stable internal and external diameters.

Step (2) includes heating while applying deformation: heat can be conveyed to the shaped article by any means; ventilated oven may be used to this aim, but any type of heating mean would be appropriate. E.g. as an alternative, deformation may be applied while maintaining the shaped article in a heating bath comprising a fluid maintained at the required heating temperature.

As said, in step (2), the shaped article is heated at a temperature equal to or exceeding melting point of polymer (F-TPE); generally, the shaped article is heated at a temperature of at least 165° C., preferably at least 170° C., more preferably at least 175° C. Upper boundaries for the heating temperature in step (2) will be selected considering minimizing heat consumption to the sake of process economics, but also considering avoiding exposure to thermal conditions which may impair integrity of the shaped articles, in view advantageously of the heat stability of the crosslinked polymer (F-TPE) which the article is made of. Generally hence in step (2) the shaped article is heated at temperatures not exceeding 250° C., preferably not exceeding 230° C., more preferably not exceeding 220° C.

Temperatures which have been found particularly adapted in step (2) of the method of the invention are comprised between 180 and 200° C., in particular between 180 and 190° C.

As said, the result of step (2) is a stretched shaped article having a heat unstable three dimensional shape which is stretched in at least one dimension with respect to the heat stable three dimensional shape of the shaped crosslinked article.

The method further comprises a step (3) of cooling said stretched shaped article to a temperature of lower than 50° C. below said melting point of polymer (F-TPE), while continuing applying the said deformation, so as to obtain the heat shrinkable article.

Means used for cooling are not particularly limited; e.g. the shaped part may be merely exposed to ambient air to let it revert to room temperature with no peculiar cooling temperature control; alternatively, a ventilated cooling device may be used for controlling cooling rate and/or a cooling bath including a coolant fluid in which the shaped article will be immersion cooled may be used.

In all cases, permanent deformation in heat unstable three dimensional shape can be achieved when the part is cooled at a temperature which is at least 50° C. below melting point of polymer (F-TPE): without being bound by this theory, the Applicant believes that the crystalline domains of the thermoplastic block of the polymer (F-TPE) which are formed through crystallization below said temperature will cause freezing the shaped article in the said heat unstable three dimensional shape.

The heat shrinkable article may be used directly as such, once got to said temperature, e.g. for being assembled or mounted in liaison with other parts, may be cooled down to room temperature for longer storage before assemblage/use.

Further, the invention pertains to a method of changing the dimensional shape of the heat shrinkable article as above detailed and/or made by the method as above detailed, said method comprising a step of heating said heat shrinkable article to a temperature equal to or exceeding melting point of polymer (F-TPE), so as to cause the said heat shrinkable article to shrink to a heat stable three dimensional shape.

This method may include a preliminary step of assembling the heat shrinkable article by engaging the same in connection with at least another part, before the said step of heating.

In said step of heating, similarly as explained for the method of making, the heat shrinkable article is heated at a temperature equal to or exceeding melting point of polymer (F-TPE); generally, the heat shrinkable article is heated at a temperature of at least 165° C., preferably at least 170° C., more preferably at least 175° C. Upper boundaries for the heating temperature will be selected considering minimizing heat consumption to the sake of process economics, but also considering avoiding exposure to thermal conditions which may impair integrity of the heat shrinkable article, in view advantageously of the heat stability of the crosslinked polymer (F-TPE) which the article is made of. Generally hence the heat shrinkable article is heated at temperatures not exceeding 250° C., preferably not exceeding 230° C., more preferably not exceeding 220° C. Temperatures which have been found particularly adapted are comprised between 180 and 200° C., in particular between 180 and 190° C.

The result of this heating step is hence a shrunk shaped article having a heat stable three dimensional shape which is shrunk in at least one dimension with respect to the heat unstable three dimensional shape of the heat shrinkable article.

Generally, shrinking will cause at least one dimension of the heat shrinkable article to be decreased by at least 30%, preferably at least 50% more preferably at least 100%, and even up to 200% or more, with respect to the corresponding heat unstable dimension of said heat shrinkable article.

Should the disclosure of any of the patents, patent applications, and publications that are incorporated herein by reference conflict with the present description to the extent that it might render a term unclear, the present description shall take precedence.

The present invention will be now described in more detail with reference to the following examples, whose purpose is merely illustrative and not limitative of the scope of the invention.

### EXAMPLES

Raw Materials

PVDF SOLEF® 1010 is a VDF homopolymer commercially available from Solvay Specialty Polymers Italy S.p.A. (referred to as 1010 herein below).

TECNOFLON® P457 FKM is a low viscosity, medium fluorine (67%), peroxide curable VDF-based fluoroelastomer, commercially available from Solvay Specialty Polymers Italy S.p.A. (referred to as P457 herein below).

### Preparative Example 1

PVDF-P(VDF-HFP)-PVDF (P(VDF-HFP) VDF: 78.5% by Moles, HFP: 21.5% by Moles)

In a 7.5 liters reactor equipped with a mechanical stirrer operating at 72 rpm, 4.5 l of demineralized water and 22 ml of a microemulsion, previously obtained by mixing 4.8 ml of a perfluoropolyoxyalkylene having acidic end groups of formula CF₂ClO(CF₂—CF(CF₃)O)ₙ(CF₂O)ₘCF₂COOH, wherein n/m=10, having an average molecular weight of 600, 3.1 ml of a 30% v/v NH₄OH aqueous solution, 11.0 ml of demineralized water and 3.0 ml of GALDEN® D02 perfluoropolyether of formula CF₃O(CF₂CF(CF₃)O)ₙ(CF₂O)ₘCF₃, wherein n/m=20, having an average molecular weight of 450, were introduced.

The reactor was heated and maintained at a set-point temperature of 85° C.; a mixture of vinylidene fluoride (VDF) (78.5% by moles) and hexafluoropropylene (HFP) (21.5% by moles) was then added to reach a final pressure of 20 bar. Then, 8 g of 1,4-diiodoperfluorobutane (C₄F₈I₂) as chain transfer agent were introduced, and 1.25 g of ammonium persulfate (APS) as initiator were introduced. Pressure was maintained at a set-point of 20 bar by continuous feeding of a gaseous mixture of vinylidene fluoride (VDF) (78.5% by moles) and hexafluoropropylene (HFP) (21.5% by moles) up to a total of 2000 g. Moreover, 0.86 g of CH₂═CH—(CF₂)₆—CH═CH₂, fed in 20 equivalent portions each 5% increase in conversion, were introduced.

Once 2000 g of monomer mixture were fed to the reactor, the reaction was discontinued by cooling the reactor to room temperature. The residual pressure was then discharged and the temperature brought to 80° C. VDF was then fed into the autoclave up to a pressure of 20 bar, and 0.14 g of ammonium persulfate (APS) as initiator were introduced. Pressure was maintained at a set-point of 20 bar by continuous feeding of VDF up to a total of 500 g. Then, the reactor was cooled, vented and the latex recovered. The latex was treated with aluminium sulphate, separated from the aqueous phase, washed with demineralized water and dried in a convection oven at 90° C. for 16 hours.

Characterization data of the polymer so obtained are reported in Table 1.

### Comparative Example 1C

A comparative composition was manufactured by mechanically mixing crumbs of P457 with powdery 1010 in an open mill together with all other compounding ingredients, as detailed in Table 2, so as to produce mechanically mixed composition consisting of 76% weight P457/24% weight filler 1010.

TABLE 1

| DSC | | Prep. Ex. 1 |
|---|---|---|
| T_{g} | [° C.] | −21.5 |
| Tₘ | [° C.] | 162.5 |
| ΔH_{f} | [J/g] | 8.6 |

| | | |
|---|---|---|
| Composition - NMR | soft (A) | hard (B) |

| | | | |
|---|---|---|---|
| VDF | [% mol] | 78.5 | 100 |
| HFP | [% mol] | 21.5 | — |

Table 2 summarize the compounding recipes and the molding/curing conditions applied for the manufacture of shaped parts from a composition of the invention (Ex. 1) and from a comparative blend, comprising substantially same fraction of VDF homopolymer reinforcing filler.

Mechanical properties were determined both at 150° C. and at 23° C.

TABLE 2

| Run | EX. 1 | Ex. 1C |
|---|---|---|
| Polymer - Compound | 100.00 | 100.00 |
| Drimix ® TAIC 75 - Finco | 3.00 | 3.00 |
| Luperox ® 101 XL 45 - Atofina | 2.00 | 2.00 |

Molding/curing conditions

| | |
|---|---|
| Molding condition | 5 min @ 170° C. |
| Postcure Condition | (1 + 4) h@230° C. |

Mechanical Properties@150° C. - DIN 53504 S2

| | | | |
|---|---|---|---|
| Tensile Strength | MPa | 10.9 | 1.8 |
| 50% Modulus | MPa | 0.7 | 1.7 |
| 100% Modulus | MPa | 1.0 | 0.0 |
| Elongation @ Break | % | 208 | 72 |

Mechanical Properties @23° C. - DIN 53504 S2

| | | | |
|---|---|---|---|
| Tensile Strength | MPa | 17.2 | 5.8 |
| 50% Modulus | MPa | 3.8 | 1.4 |
| 100% Modulus | MPa | 5.2 | 2.1 |
| Elongation @ Break | % | 422 | 319 |
| Hardness | ShA | 78 | 64 |

Data comprised in Table above well demonstrate that the reinforcing effect of the VDF homopolymer block (B) in the polymer (F-TPE) is significantly more effective than what is obtained by blending fluororubber and thermoplast in substantially analogous amount, while providing for increased elongation at break, hence, overall improved elasticity/deformability.

Heat Shrinking Test

Both polymers (Ex.1 and Ex.1C) were tested for their ability to provide for heat shrinkable parts. Specimens of crosslinked part made from either the composition of the invention (Ex. 1) or the comparative blend (Ex. 1C) having a gauge length of dimension (3×1.2) cm and a thickness of about 2 mm were stretched at 185° C. (above melting temperature of PVDF phase) applying a strain of 33% (i.e. ‘till a length of 4 cm). The specimens were cooled down to room temperature (about 23° C.) without releasing the applied stress, i.e. maintaining deformation.

Once the stress was removed, substantially no recovery was observed for both specimens. Upon heating at a temperature of 185° C., the specimens recovered precisely their original un-deformed dimension (3 cm). Hence, at low strain, substantially same findings were demonstrated for both the parts made from the composition of the invention and for the comparative blend of reinforced fluororubber comprising substantially similar weight fraction of PVDF thermoplastic filler.

The same procedure was repeated increasing the initial strain at 185° C.: three different attempts were performed, at a strain equal to 100% and 150% were carried out. The material Ex.1 was elongated with no issue at all different strains showing recovery after at least 5 cycles of cooling and heating while the Ex.1C broke due to a lower elongation at break in temperature, when attempting to stretch the same under a strain of 100% or 150%.

Data so collected clearly demonstrate that the composition of the invention offers advantageous behaviour when used for manufacturing heat-shrinkable objects over compounds which are reinforced by addition of thermoplasts.

1.-15. (canceled)

16. A heat shrinkable article made from a composition [composition (C)] comprising:
at least one fluorinated thermoplastic elastomer [polymer (F-TPE)] comprising:
(i) at least one elastomeric block (A) consisting of a sequence of recurring units, said sequence comprising recurring units derived from at least one fluorinated monomer, said block (A) possessing a glass transition temperature of less than 25° C., as determined according to ASTM D3418,
(ii) at least one thermoplastic block (B) consisting of a sequence of recurring units derived from vinylidene fluoride (VDF) in an amount of more than 80% moles, with respect to the total moles of units of block (B), and optionally from one or more than one additional fluorinated monomer different from VDF,
wherein:
polymer (F-TPE) comprises a detectable melting point, when determined according to ASTM D3418; and
polymer (F-TPE) comprises a heat of fusion of at least 2.5 J/g and of at most 20.0 J/g, when determined according to ASTM D3418; and
(iii) iodine and/or bromine cure sites in an amount such that the overall iodine and/or bromine content of the polymer (F-TPE) is of 0.01 to 10.00% wt, with respect to the total weight of polymer (F-TPE);
at least one organic peroxide [peroxide (0)]; and
at least one polyunsaturated compound [compound (U)].

17. The heat shrinkable article of claim 16, wherein the polymer (F-TPE) comprises:
at least one elastomeric block (A) selected from the group consisting of:
(1) vinylidene fluoride (VDF)-based elastomeric blocks (A_{VDF}) consisting of a sequence of recurring units, said sequence comprising recurring units derived from VDF and recurring units derived from at least one fluorinated monomer different from VDF, said fluorinated monomer different from VDF selected from the group consisting of:
(a) C₂-C₈ perfluoroolefins such as tetrafluoroethylene (TFE), hexafluoropropylene (IFP);
(b) hydrogen-containing C₂-C₈ fluoroolefins different from VDF;
(c) C₂-C₈ chloro-containing fluoroolefins;
(d) perfluoroalkylvinylethers (PAVE) of formula CF₂═CFOR_{f1}, wherein R_{f1} is a C₁-C₆ perfluoroalkyl group;
(e) perfluorooxyalkylvinylethers of formula CF₂═CFOX₀, wherein Xo is a a C₁-C₁₂ perfluorooxyalkyl group comprising one or more than one ethereal oxygen atom; and
(f) (per)fluorodioxoles of formula: 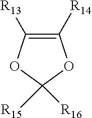
wherein each of R_{f3}, R_{f4}, R_{f5} and R_{f6}, equal to or different from each other, is independently a fluorine atom, a C₁-C₆ perfluoro(oxy)alkyl group, optionally comprising one or more oxygen atoms, such as —CF₃, —C₂F₅, —C₃F₇, —OCF₃ or —OCF₂CF₂OCF₃;
(g) bromo and/or iodo alpha-olefins containing from 2 to 10 carbon atoms; and
(h) iodo and/or bromo fluoroalkyl vinyl ethers; and
(2) tetrafluoroethylene (TFE)-based elastomeric blocks (A_{TFE}) consisting of a sequence of recurring units, said sequence comprising recurring units derived from TFE and recurring units derived from at least one fluorinated monomer different from TFE;
at least one thermoplastic block (B) consisting of a sequence of recurring units derived from vinylidene fluoride (VDF) in an amount of more than 80% moles, with respect to the total moles of units of block (B), and optionally from one or more than one additional fluorinated monomer different from VDF.

18. The heat shrinkable article of claim 17, wherein the elastomeric block (A) is a block (A_{VDF}) consisting of a sequence of recurring units comprising:
from 45% to 80% by moles of recurring units derived from vinylidene fluoride (VDF),
from 5% to 50% by moles of recurring units derived from at least one fluorinated monomer different from VDF,
optionally, up to 1.0% by moles of recurring units derived from at least one one bis-olefin [bis-olefin (OF)] of formula:
R_{A}R_{B}═CR_{C}-T-CR_{D}═R_{E}R_{F}
wherein R_{A}, R_{B}, R_{C}, R_{D}, R_{E} and R_{F}, equal to or different from each other, are selected from the group consisting of H, F, Cl, C₁-C₅ alkyl groups and C₁-C₅ (per)fluoroalkyl groups, and T is a linear or branched C₁-C₁₈ alkylene or cycloalkylene group, optionally comprising one or more than one ethereal oxygen atom, or a (per)fluoropolyoxyalkylene group; and
optionally, up to 30% by moles of recurring units derived from at least one hydrogenated monomer,
with respect to the total moles of recurring units of the sequence of block (A_{VDF}).

19. The heat shrinkable article of claim 18, wherein block (B) is selected from the group consisting of blocks (B_{VDF}) consisting of a sequence of recurring units derived from vinylidene fluoride and optionally from one or more than one additional fluorinated monomer different from VDF; and optionally from a hydrogenated monomer;
wherein the amount of recurring units derived from VDF is of 85 to 100% moles, based on the total moles of recurring units of block (B_{VDF}).

20. The heat shrinkable article of claim 19, wherein the weight ratio between blocks (A) and blocks (B) in the fluorinated thermoplastic elastomer is between 95:5 and 70:30 and/or polymer (F-TPE) comprises a heat of fusion (ΔH_{f}) of at most 20 J/g, as determined according to ASTM D3418.

21. The heat shrinkable article of claim 19, wherein polymer (F-TPE) is selected from the group consisting of those comprising:
at least one elastomeric block (A_{VDF}), and
at least one thermoplastic block (B_{VDF}), and
wherein polymer (F-TPE) comprises a heat of fusion of at least 5 J/g and at most 15 J/g, as determined according to ASTM D3418.

22. The heat shrinkable article according to claim 16, wherein iodine and/or bromine cure sites are pending groups bound to the backbone of the polymer (F-TPE) polymer chain or are terminal groups of said polymer chain.

23. The heat shrinkable article according to claim 22, wherein the iodine and/or bromine cure sites are terminal groups of the polymer (F-TPE) polymer chain and are obtained by addition to a polymerization medium during polymer (F-TPE) manufacture of at least one of:
iodinated and/or brominated chain-transfer agent(s); and
alkali metal or alkaline-earth metal iodides and/or bromides.

24. The heat shrinkable article according to claim 16, wherein the composition (C) further comprises at least one organic peroxide [peroxide (0)], each of which is selected from the group consisting of:
di(alkyl/alryl) peroxides, including for instance di-tert-butyl peroxide, 2,5-dimethyl-2,5-bis(tert-butylperoxy)hexane, di(t-butylperoxyisopropyl)benzene, dicumyl peroxide;
diacyl peroxides, including dibenzoyl peroxide, disuccinic acid peroxide, di(4-methylbenzoyl)peroxide, di(2,4-dichlorobenzoyl)peroxide, dilauroyl peroxide, decanoyl peroxide;
percarboxylic acids and esters, including di-tert-butyl perbenzoate, t-butylperoxy-2-ethylhexanoate, 1,1,3,3-tetramethylethylbutyl peroxy-2-ethylhexanoate, 2,5-dimethyl-2,5-di(2-ethylhexanoylperoxy)hexane;
peroxycarbonates,
perketals;
ketone peroxides;
organic hydroperoxides;
oil-soluble azo initiators;
and/or wherein the amount of peroxide (O) in the composition (C) is from 0.1 to 15 phr, relative to 100 weight parts of polymer (F-TPE).

25. The heat shrinkable article according claim 16, wherein composition (C) comprises at least one compound (U) selected from the group of compounds comprising two carbon-carbon unsaturations, compounds comprising three carbon-carbon unsaturations and compounds comprising four or more than four carbon-carbon unsaturations;
wherein compounds (U) comprising two carbon-carbon unsaturations are selected from the group consisting of bis-olefins [bis-olefin (OF)], of formula:
R_{A}R_{B}═CR_{C}-T-CR_{D}═R_{E}R_{F}
wherein R_{A}, R_{B}, R_{C}, R_{D}, R_{E} and R_{F}, equal to or different from each other, are selected from the group consisting of H, F, Cl, C₁-C₅ alkyl groups and C₁-C₅ (per)fluoroalkyl groups, and T is a linear or branched C₁-C₁₈ alkylene or cycloalkylene group, optionally comprising one or more than one ethereal oxygen atom, or a (per)fluoropolyoxyalkylene group;
wherein compounds (U) comprising three carbon-carbon unsaturations are selected from the group consisting of:
tri-substituted cyanurate compounds of general formula: 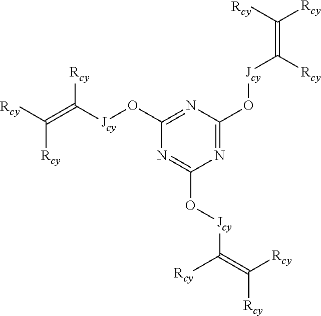
wherein each of R_{cy}, equal to or different from each other and at each occurrence, is independently selected from H or a group —R_{rcy} or —OR_{rcy}, with R_{rcy} being C₁-C₅ alkyl, optionally comprising halogen(s), and each of J_{cy}, equal to or different from each other and at each occurrence, is independently selected from a bond or a divalent hydrocarbon group, optionally comprising heteroatoms;
tri-substituted isocyanurate compounds of general formula: 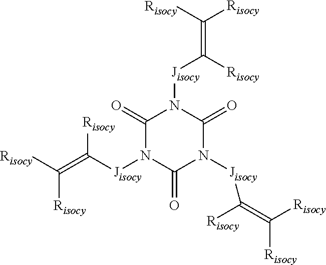
wherein each of R_{isocy}, equal to or different from each other and at each occurrence, is independently selected from H or a group —R_{risocy} or —OR_{risocy}, with R_{risocy} being C₁-C₅ alkyl, optionally comprising halogen(s), and each of J_{isocy}, equal to or different from each other and at each occurrence, is independently selected from a bond or a divalent hydrocarbon group, optionally comprising heteroatoms;
tri-substituted triazine compounds of general formula: 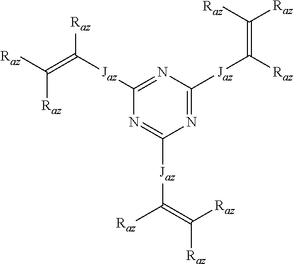
wherein each of R_{az}, equal to or different from each other and at each occurrence, is independently selected from H or a group —R_{raz} or —OR_{raz}, with R_{raz} being C₁-C₅ alkyl, possibly comprising halogen(s), and each of J_{az}, equal to or different from each other and at each occurrence, is independently selected from a bond or a divalent hydrocarbon group, optionally comprising heteroatoms;
tri-substituted phosphite compounds of general formula: 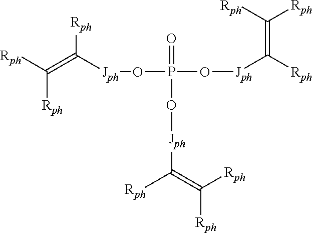
wherein each of Rₚₕ, equal to or different from each other and at each occurrence, is independently selected from H or a group —Rᵣₚₕ or —ORᵣₚₕ, with Rᵣₚₕ being C₁-C₅ alkyl, possibly comprising halogen(s), and each of Jₚₕ, equal to or different from each other and at each occurrence, is independently selected from a bond or a divalent hydrocarbon group, optionally comprising heteroatoms;
tri-substituted alkyltrisiloxanes of general formula: 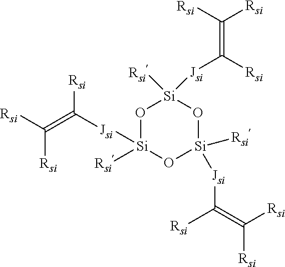
wherein each of Rₛᵢ, equal to or different from each other and at each occurrence, is independently selected from H or a group —Rᵣₛᵢ or —ORᵣₛᵢ, with Rᵣₛᵢ being C₁-C₅ alkyl, possibly comprising halogen(s), each of R′ₛᵢ, equal to or different from each other and at each occurrence, is independently selected from C₁-C₅ alkyl groups, possibly comprising halogen(s), and each of Jₛᵢ, equal to or different from each other and at each occurrence, is independently selected from a bond or a divalent hydrocarbon group, optionally comprising heteroatoms;
N,N-disubstituted acrylamide compounds of general formula: 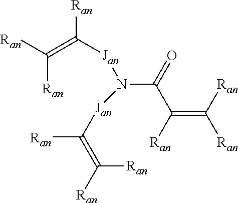
wherein each of Rₐₙ, equal to or different from each other and at each occurrence, is independently selected from H or a group —Rᵣₐₙ or —ORᵣₐₙ, with Rᵣₐₙ being C₁-C₅ alkyl, possibly comprising halogen(s), and each of Jₐₙ, equal to or different from each other and at each occurrence, is independently selected from a bond or a divalent hydrocarbon group, optionally comprising heteroatoms;
wherein compounds (U) comprising four or more carbon-carbon unsaturations are selected from the group consisting of tris(diallylamine)-s-triazines of formula 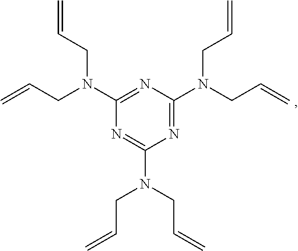 [SMILES: C=CCN(CC=C)c1nc(N(CC=C)CC=C)nc(N(CC=C)CC=C)n1]
hexa-allylphosphoramide, N,N,N′,N′-tetra-allyl terephthalamide, N,N,N′,N′-tetra-allyl malonamide.

26. The heat shrinkable article according to claim 16, wherein the amount of the compound (U) ranges from 0.1 to 20 weight parts per 100 parts by weight (phr) of polymer (F-TPE).

27. The heat shrinkable article according to claim 16, wherein the heat shrinkable article is selected from the group consisting of sleeves, tubes, tubings, O-rings, seals, and gaskets.

28. A method of making a heat shrinkable article, said method comprising:
(1) a step of shaping and crosslinking a composition [composition (C)] comprising:
at least one fluorinated thermoplastic elastomer [polymer (F-TPE)] comprising:
(i) at least one elastomeric block (A) consisting of a sequence of recurring units, said sequence comprising recurring units derived from at least one fluorinated monomer, said block (A) comprising a glass transition temperature of less than 25° C., as determined according to ASTM D3418,
(ii) at least one thermoplastic block (B) consisting of a sequence of recurring units derived from vinylidene fluoride (VDF) in an amount of more than 80% moles, with respect to the total moles of units of block (B), and optionally from one or more than one additional fluorinated monomer different from VDF,
wherein:
polymer (F-TPE) has a detectable melting point, when determined according to ASTM D3418; and
polymer (F-TPE) comprises heat of fusion of at least 2.5 J/g and of at most 20.0 J/g, when determined according to ASTM D3418; and
(iii) iodine cure site in an amount such that the iodine content of the polymer (F-TPE) is of 0.01 to 1.00% wt, with respect to the total weight of polymer (F-TPE);
at least one organic peroxide [peroxide (O)]; and
at least one polyunsaturated compound [compound (U)];
so as to obtain a shaped crosslinked article having a heat stable three dimensional shape;
(2) a step of heating the said shaped article at a temperature equal to or exceeding melting point of polymer (F-TPE) while applying a deformation, so as to obtain a stretched shaped article having a heat unstable three dimensional shape which is stretched in at least one dimension with respect to the heat stable three dimensional shape of the shaped crosslinked article; and
(3) a step of cooling said stretched shaped article to a temperature of lower than 50° C. below said melting point of polymer (F-TPE), while continuing applying the said deformation, so as to obtain the heat shrinkable article.

29. The method of claim 28, wherein the composition (C) is shaped and crosslinked according any of injection moulding, compression moulding, extrusion moulding, coating, screen printing technique, form-in-place techniques.

30. The method of claim 28, wherein deformation is applied in one or more dimensions, while the deformation induced impacts all the characterizing dimensions of the shaped article and/or wherein deformation causes at least one dimension of the shaped article to be increased by at least 30%, with respect to the original corresponding heat stable dimension; and/or
wherein in Step (2) heating comprises using a ventilated oven or comprises maintaining the shaped article in a heating bath comprising a fluid maintained at the required heating temperature, and wherein the shaped article is heated at a temperature of at least 165° C. and at a temperature not exceeding 250° C.

31. A method of changing the dimensional shape of the heat shrinkable article according to claim 16, said method comprising a step of heating said heat shrinkable article to a temperature equal to or exceeding melting point of polymer (F-TPE), so as to cause the said heat shrinkable article to shrink to a heat stable three dimensional shape.
